(19) United States
(12) Patent Application Publication
(10) Pub. No.: US 2026/0133767 A1
(43) Pub. Date: May 14, 2026

(54) CUSTOM WEBPAGE CODE CONVERSION USING GENERATIVE ARTIFICIAL INTELLIGENCE

(71) Applicant: Adobe Inc., San Jose, CA (US)

(72) Inventors: Yaman Kumar, New Delhi (IN); Varun Khurana, New Delhi (IN); Tobias Reiss, Munich (DE); Rishabh Jain, Gurgaon (IN); Nursinem Dere, Basel (CH); Dragos Dascalita Haut, Haiku, HI (US); David Catalan, Paris (FR)

(73) Assignee: Adobe Inc., San Jose, CA (US)

(21) Appl. No.: 18/947,722

(22) Filed: Nov. 14, 2024

(51) Int. Cl. G06F 8/30; G06F 16/958

(52) U.S. Cl. CPC G06F 8/30; G06F 16/958

(57) ABSTRACT

In accordance with the described techniques, a code conversion system receives a digital image of a webpage. Using an object detection model, the code conversion system detects a webpage block in the digital image, as well as a block class assigned to the webpage block. In addition, the code conversion system extracts webpage content of the webpage block from source code of the webpage. Using a generative artificial intelligence (AI) model, the code conversion system generates custom code formatted in accordance with a webpage publication system based on the webpage block, the block class, and the webpage content.

### BACKGROUND

Webpage publication systems are tools for creating, managing, and publishing digital content online. Many webpage publication systems offer intuitive user interfaces and templates for webpage customization, enabling users to build and edit webpages without in-depth coding knowledge. Indeed, webpage publication systems include functionality for converting user-customized webpage interface templates to structured web content including hypertext markup language (HTML) code of the webpage. Due to system-specific content delivery mechanisms and/or system-specific customizable webpage components, the HTML code is specifically adapted to the webpage publication system.

### SUMMARY

A code conversion system is described that is configured to receive a digital image of a webpage. Based on the digital image, an object detection model detects a webpage block in the digital image, and a block class assigned to the webpage block. In particular, the block class is selected from a plurality of block classes corresponding to different user interface webpage components of a webpage publication system. The webpage publication system, for instance, enables users to build, edit, and publish webpages using modular webpage blocks. Different block classes correspond to different formatting, structures and/or functionalities of the webpage blocks.

The code conversion system extracts webpage content of the webpage block from source code (e.g., HTML code) of the webpage. For instance, the code conversion system identifies multiple webpage components based on elements of the source code defining distinct sections of a webpage layout. Furthermore, the code conversion system matches a webpage component to the webpage block based on a degree of overlap between the webpage component and the webpage block, and extracts webpage content (e.g., text content, image content, video content, audio content) from source code associated with the webpage component.

Based on the webpage block, the block class of the webpage block, and the webpage content of the webpage block as conditioning signals, a generative artificial intelligence model generates custom code (e.g., HTML code) formatted in accordance with the webpage publication system. For instance, the generative AI model is trained to generate custom code (e.g., HTML code) following code formatting guidelines specific to the webpage publication system based on training data extracted from source code of existing webpages built on and published via the webpage publication system.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ techniques described herein for custom webpage code conversion using generative artificial intelligence.

FIG. 2 depicts a system in an example implementation showing operation of a code conversion system to convert a webpage to custom code formatted in accordance with a webpage publication system.

FIG. 3 depicts a system in an example implementation showing operation of the code conversion system to extract training data from existing webpages formatted in accordance with the webpage publication system.

FIG. 4 depicts a system in an example implementation showing operation of the code conversion system to train an object detection model to detect webpage blocks and corresponding block classes of a webpage publication system.

FIG. 5 depicts a system in an example implementation showing operation of the code conversion system to train a generative artificial intelligence model to generate custom code of a webpage publication system.

FIGS. 6a-6c depict examples of a user interface of the described techniques for custom webpage code conversion using generative artificial intelligence.

FIG. 7 is a flow diagram depicting a procedure in an example implementation of using a generative artificial intelligence model to convert a webpage to custom webpage code formatted in accordance with a webpage publication system.

FIG. 8 is a flow diagram depicting a procedure in an example implementation of training a generative artificial intelligence model to convert a webpage to custom webpage code formatted in accordance with a webpage publication system.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

### Overview

A webpage publication system is a platform, web application, and/or or software that enables users to create, manage, and publish web content. The webpage publication system is designed to simplify the process of designing, editing, and organizing web content (e.g., text, images, video, audio, and multimedia) by using modular webpage blocks of different block classes for building a webpage. A webpage block is a modular user interface component that acts as a building block for a webpage, and a block class is a particular type of webpage block. For instance, a webpage block is conceptualizable as a user interface template, and different block classes represent different designs of the user interface template. Indeed, different block classes include different styles, formatting, structures, and/or functionalities within a webpage block.

In addition, the webpage publication system employs edge delivery to deliver webpages published via the webpage publication system to end-users accessing the webpages. Edge delivery, for instance, refers to the process of delivering web content from servers that are geographically proximate to end-users, thereby reducing the physical distance that data travels, reducing content delivery latency, and enhancing data load speeds.

In comparison to a standard webpage, therefore, a webpage formatted in accordance with the webpage publication system offers various advantages. Indeed, the webpage publication system offers increased webpage authoring efficiency by enabling a webpage developer to populate standard, reusable webpage blocks. Moreover, the webpage publication system provides edge delivery services which increases content delivery speeds and reduces content download times.

For these reasons, entities (e.g., companies, brands, enterprises) often desire to convert a webpage to the webpage publication system. However, the webpage publication system uses system-specific webpage blocks, block classes, and code formatting guidelines. Due to this, conversion of a webpage to the webpage publication system involves generating system-specific, custom code following the code formatting guidelines of the webpage publication system.

Conventional techniques for converting a webpage to system-specific code of a webpage publication system involve developers analyzing the webpage to manually generate the system-specific code. This is a time consuming and tedious process. Accordingly, the techniques described herein relate to automatically generating custom code formatted in accordance with the webpage publication system based on a digital image of the webpage and source code of the webpage.

In accordance with the described techniques, a code conversion system receives a webpage having a webpage image (e.g., a screenshot of the webpage), and source code (e.g., HTML code) of the webpage. The webpage image is provided to an object detection model, which is a machine learning model having been trained to identify system-specific webpage blocks, and assign system-specific block classes to the webpage blocks. To train the model, training data is extracted from existing webpages built on and published via the webpage publication system. The training data includes ground truth webpage blocks having ground truth block classes extracted from source code (e.g., HTML code) of the existing webpages. Further, the object detection model is trained and/or finetuned on this training data to learn to produce outputs (e.g., detected webpage blocks and block classes) that reflect the training data, e.g., the webpage blocks and block classes of existing webpages of the webpage publication system. At inference time, the object detection model outputs a plurality of webpage blocks detected in the webpage image, and a block class assigned to each webpage block.

The code conversion system is further configured to match webpage content (e.g., text content, image content, video content, audio content) output as part of the user interface of the webpage to corresponding webpage blocks. To do so, the code conversion system extracts a document object model (DOM) from the HTML code. In addition, the code conversion system identifies, as webpage components, <div> elements of the HTML code and/or DOM structure, and determines coordinates of the <div> elements. Notably, a <div> element represents a distinct section of a logical layout of a webpage. Given a webpage block, the code conversion system determines a degree of overlap (e.g., an intersection over union (IoU)) of the webpage block with respect to each detected <div> element. Further, the code conversion system matches the webpage block to a particular <div> element exhibiting a highest degree of overlap with the webpage block. The code conversion system additionally assigns the webpage content within the <div> element of the DOM structure to the webpage block. This process is repeated for each detected webpage block.

The webpage blocks each including an assigned block class and assigned webpage content are provided as input to a generative artificial intelligence (AI) model. Broadly, the generative AI model is a multimodal machine learning model (e.g., a multimodal large language model (MLLM)) designed to process inputs and/or generate outputs in multiple content modalities, e.g., text, image, video, audio. In particular, the generative AI model is trained to produce the custom code formatted in accordance with the webpage publication system for a webpage block having an assigned block class and assigned webpage content.

To train the generative AI model, training data is extracted from existing webpages built on and published via the webpage publication system. The training data includes a plurality of training samples. Each training sample includes a ground truth webpage block, a ground truth block class of the ground truth webpage block, and webpage content of the ground truth webpage block. Notably, this data is extracted from the source code (e.g., HTML code) of an existing webpage. As such, the ground truth source code is formatted in accordance with the code formatting guidelines of the webpage publication system. Given a training sample, the generative AI model is leveraged to generate predicted custom code based on the ground truth webpage block, the ground truth block class, and the webpage content of the training sample. Further, parameters (e.g., internal weights) of the generative AI model are updated based on a comparison of the predicted custom code and the ground truth source code. This process is repeated on different training samples. Accordingly, the generative AI model is trained and/or finetuned to generate outputs (e.g., custom code) that reflect the training data, e.g., the ground truth source code having the system-specific, custom formatting.

At inference time, the generative AI model receives, as conditioning signals, a segmented image of the webpage block, an indication of the block class, and the webpage content. In particular, different modalities of the webpage content are provided to the generative AI model via different input channels. Based on the provided input data, the generative AI model generates the custom code for the webpage block. This process is repeated for each detected webpage block, with the generative AI model individually processing each detected webpage block. As a result, the generative AI model produces custom code for the entire webpage, which is output for display in a user interface.

Thus, the described techniques use machine learning to automatically convert a webpage to custom code formatted in accordance with the webpage publication system. By doing so, the described techniques significantly speed up the webpage conversion process and alleviate developers of tedious manual webpage conversion tasks. This also conserves computational resources (e.g., processing, memory, and bandwidth resources) typically consumed by developers manually converting webpages to the webpage publication system. Moreover, since the webpage publication system utilizes edge delivery, generation of the custom code by the code conversion system is conceptualizable as converting the webpage to a format that enables and/or optimizes edge delivery. This reduces content delivery latency and load times for end-users accessing the converted webpage online.

### Term Descriptions

As used herein, the term “webpage publication system” refers to a platform, web application, and/or software that enables users to create, edit, manage, and publish web content. In one or more implementations, the webpage publication system enables users to build webpages by inserting and customizing modular webpage blocks of various block classes.

As used herein, the term “webpage block” refers to a modular user interface component that acts as a building block for a webpage. In one or more implementations, a webpage block is a user interface template that is reusable by different users of the webpage publication system and customizable with content of one or more content modalities, e.g., text content, image content, video content, audio content, and so on. For instance, a webpage block includes default placements for user-populatable content elements, such as headings, text, images, lists, links, buttons, code, icons, and so on.

As used herein, the term “block class” refers to a particular type of webpage block. Different block classes represent different webpage user interface components that are capable of being created, edited, and published online by users of the webpage publication system. For instance, different block classes include different user interface templates having different user-populatable content elements and/or different placements of the user-populatable content elements.

As used herein, the term “custom code” refers to source code (e.g., HTML code) of a webpage that is formatted in accordance with code formatting guidelines of the webpage publication system. Indeed, due to the system-specific webpage blocks and block classes as well as system-specific content delivery mechanisms used by the webpage publication system, source code of webpages built on the webpage publication system follow code formatting guidelines (e.g., also referred to as “custom formatting”) that are specific to the webpage publication system.

As used herein, the term “webpage content” refers to content that is output as part of a user interface of a webpage. Webpage content, for instance, includes text content, image content, video content, and audio content.

As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, a machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

As used herein, the term “object detection model” refers to a type of machine learning model designed and/or trained to identify and locate specific objects within visual data, e.g., images and videos. In the context of the described techniques, for example, an object model is trained to detect webpage blocks and assign block classes to the webpage blocks in digital images (e.g., screenshots) of webpages. A no-limiting example of the object detection model is a YOLOv8 model.

As used herein, the term “generative AI model” refers to a type of machine learning model designed and/or trained to generate data (e.g., text, images, videos, and audio) based on input data. In various implementations, the generative AI model is a multimodal machine learning model, designed to process inputs in multiple content modalities, e.g., text, image, video, audio. In the context of the described techniques, for example, the generative AI model is trained to generate the custom code for a webpage block based on input data including the webpage block, a block class assigned to the webpage block, and webpage content of the webpage block. A non-limiting example of the object detection model is an intern VL2-8B model.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

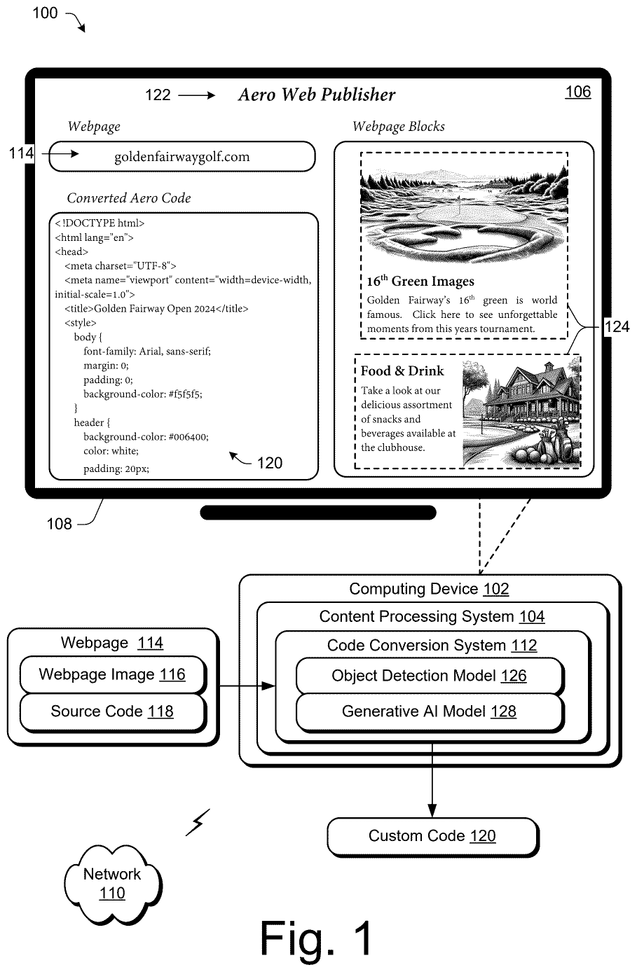

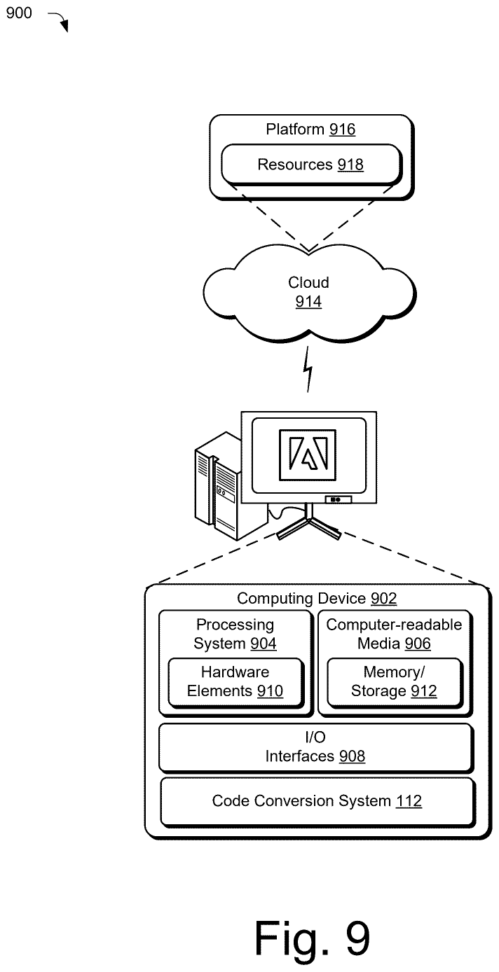

FIG. 1 is an illustration of an environment 100 in an example implementation that is operable to employ techniques described herein for custom webpage code conversion using generative artificial intelligence. The illustrated environment 100 includes a computing device 102, which is configurable in a variety of ways. The computing device 102, for instance, is configurable as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 9.

The computing device 102 is illustrated as including a content processing system 104. The content processing system 104 is implemented at least partially in hardware of the computing device 102 to process and transform digital content. Such processing includes creation of the digital content, modification of the digital content, and rendering of the digital content in a user interface 106 for output, e.g., by a display device 108. Although illustrated as implemented locally at the computing device 102, functionality of the content processing system 104 is also configurable as whole or part via functionality available via the network 110, such as part of a web service or “in the cloud.”

An example of functionality incorporated by the content processing system 104 to process the digital content is illustrated as a code conversion system 112. In general, the code conversion system 112 is configured to receive a webpage 114 having a webpage image 116 and source code 118. The webpage image 116, for instance, is a digital image of the webpage 114, e.g., a screenshot of the webpage 114. Broadly, the code conversion system 112 is configured to generate, based on the webpage image 116 and the source code 118, custom code 120 formatted in accordance with a webpage publication system 122, e.g., illustrated as “Aero Web Publisher.” In one or more implementations, the source code 118 and the custom code 120 include or correspond to a markup language, e.g., hypertext markup language (HTML).

In accordance with the described techniques, the webpage publication system 122 (e.g., also referred to as a content management system) is a platform, web application, and/or or software that enables users to create, manage, and publish web content. The webpage publication system 122, for instance, is designed to simplify the process of designing, editing, and organizing web content, e.g., text, images, video, audio, and multimedia. By doing so, the webpage publication system 122 enables webpage creation, management, and publication by users without extensive technical and/or coding experience. In one or more implementations, the webpage publication system 122 employs the use of webpage blocks 124 to build a webpage. Notably, a webpage block 124 is a modular user interface component that acts as a building block for a webpage. Examples of webpage blocks 124 include headers, footers, hero sections, web content arrangement templates, and the like.

Here, the source code 118 of the webpage 114 is not formatted in accordance with the webpage publication system 122. For instance, content of the webpage 114 is not formatted in webpage blocks 124 specific to the webpage publication system 122, and the source code 118 does not follow code formatting guidelines specific to the webpage publication system 122. To convert the webpage 114, an object detection model 126 (e.g., a machine learning model) receives the webpage image 116, and detects webpage blocks 124 and block classes assigned to the webpage blocks 124. Block classes, for instance, are types of webpage blocks 124 (e.g., webpage components) that are creatable, editable, and publishable via the webpage publication system 122.

Furthermore, a generative artificial intelligence (AI) model 128 receives input data including the source code 118 as well as the detected webpage blocks 124 and the block classes assigned thereto. Based on the input data, the generative AI model generates the custom code 120 (e.g., HTML) formatted in accordance with the code formatting guidelines specific to the webpage publication system 122. As shown, the user interface 106 includes indications of the webpage blocks 124, as well as the custom code 120. It should be noted that the custom code 120 of FIG. 1 is merely illustrative, and does not reflect functional code following the code formatting guidelines of the webpage publication system 122.

Conventional techniques for converting a standard webpage to a custom webpage formatted in accordance with the webpage publication system 122 involve developers analyzing the webpage 114 and the source code 118 to manually generate the custom code 120. However, due to code formatting guidelines and webpage blocks 124 that are specific to the webpage publication system 122, the process of manually converting a webpage 114 to the webpage publication system 122 is a time consuming and tedious process. Here, the described techniques use machine learning to automatically detect system-specific webpage blocks 124 and generate custom code 120 formatted in accordance with the webpage publication system 122. By doing so, the described techniques significantly speed up the webpage conversion process, alleviate developers of tedious manual webpage conversion tasks, and reduce computational resource consumption typically used during manual webpage conversion.

### Code Conversion Features

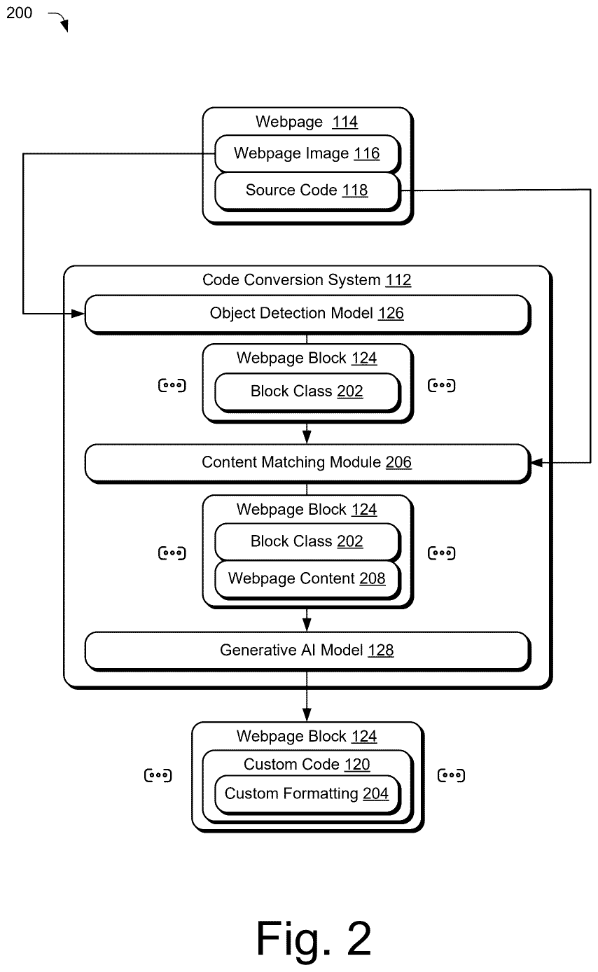

FIG. 2 depicts a system 200 in an example implementation showing operation of a code conversion system to convert a webpage to custom code formatted in accordance with a webpage publication system. As shown, the code conversion system 112 receives the webpage 114 having the webpage image 116 and the source code 118. In various implementations, the webpage image 116 is a digital image (e.g., a screenshot) of the webpage 114. Further, the source code 118 includes or corresponds to code written in a markup language (e.g., HTML) in a format that differs from the code formatting guidelines of the webpage publication system 122. For example, the source code 118 is generic HTML code or HTML code formatted in accordance with a different webpage publication system or content management system. Broadly, the code conversion system 112 is configured to generate custom code 120 formatted in accordance with the webpage publication system 122 based on the webpage image 116 and the source code 118.

As previously mentioned, the webpage publication system 122 is a platform, web application, and/or or software that enables users to create, manage, and publish web content. The webpage publication system 122, for instance, is designed to simplify the process of designing, editing, and organizing web content (e.g., text, images, video, audio, and multimedia) by using modular webpage blocks 124 (e.g., user interface templates) for building a webpage. Webpage blocks 124 are classifiable in different block classes 202 having different styles, formatting, structures, and/or functionalities within the webpage blocks 124. Examples of different block classes 202 include hero sections (e.g., prominent, visually salient areas, typically at the top of a webpage, introducing the webpage), columns (e.g., content formulated in columns), card sections (e.g., self-contained blocks of information each including an image, a title, a text snippet, and/or a link), tables (e.g., content formulated in rows and columns of a table), headers (e.g., content, typically at the top of a webpage, often including a webpage logo main navigation menu, search bar, and links to essential pages, such as “contact,” “about,” and “login”), and footers, e.g., content, typically at the bottom of a webpage, including secondary navigation links, contact information, and legal information.

In various implementations, the webpage publication system 122 employs edge delivery to deliver webpages formatted in accordance with the webpage publication system 122 to end-users accessing the webpages. By way of example, the webpage publication system 122 includes a content delivery network (CDN) having a plurality of edge servers that are geographically scattered throughout a serviced geographic area. Edge delivery causes delivery of web content from servers that are geographically proximate to end-users, thereby reducing the physical distance that data travels, reducing content delivery latency, and enhancing data load speeds. Formulation of webpages in standardized webpage blocks 124 enhances edge delivery functionality. Indeed, by organizing content of a webpage into modular, reusable webpage blocks 124, each webpage block 124 is capable of being independently pre-rendered, and cached at the edge servers of the CDN. In other words, the webpage is statically published to the edge servers of the CDN, which further enhances data load speeds as compared to dynamic content generation methods in which each user request generates new content in real-time at the server.

Additionally or alternatively, the webpage publication system 122 offers webpage creation and/or editing via common and accessible document management applications and/or interfaces. For example, a user creates a document using these document management applications in any one of a variety of file formats (e.g., .doc, .docx, .xls, .xlsx .gsheet, and .gdoc), and the document includes the webpage blocks 124. Further, the webpage publication system 122 includes functionality for transforming the document to structured web content, including custom code 120 (e.g., HTML) formatted in accordance with code formatting guidelines specific to the webpage publication system 122.

Accordingly, in comparison to a standard webpage, a webpage of the webpage publication system 122 provides numerous advantages for developers and end-users. Firstly, the webpage publication system 122 provides increased authoring (webpage creation and editing) efficiency by enabling a developer to populate standardized webpage blocks 124 via common and accessible content editing tools. Moreover, the webpage publication system 122 provides edge delivery services which reduces content delivery latency (e.g., the delay between a browser sending a request for content to a server and the server returning the requested content) and load times for end-users accessing the webpage online. In various implementations, the webpage publication system 122 additionally provides webpage monitoring functionality to developers, e.g., surfacing real-time insights regarding webpage performance, providing real user monitoring (RUM) functionality, and the like. Additionally or alternatively, the webpage publication system 122 provides omni-channel content delivery functionality, e.g., the ability to deliver content across multiple channels, such as websites, mobile apps, and the like.

For at least these reasons, entities often desire to transition standard webpages 114 and/or webpages 114 published via other content management systems to the webpage publication system 122. However, the webpage publication system 122 uses system-specific webpage blocks 124, block classes 202, and code formatting guidelines. Due to this, conversion of a webpage 114 to the webpage publication system 122 involves generating system-specific, custom code 120 having custom formatting 204 (e.g., following the code formatting guidelines) associated with the webpage publication system 122. The code conversion system 112 is representative of functionality for automating the process of generating the custom code 120 from a standard webpage 114.

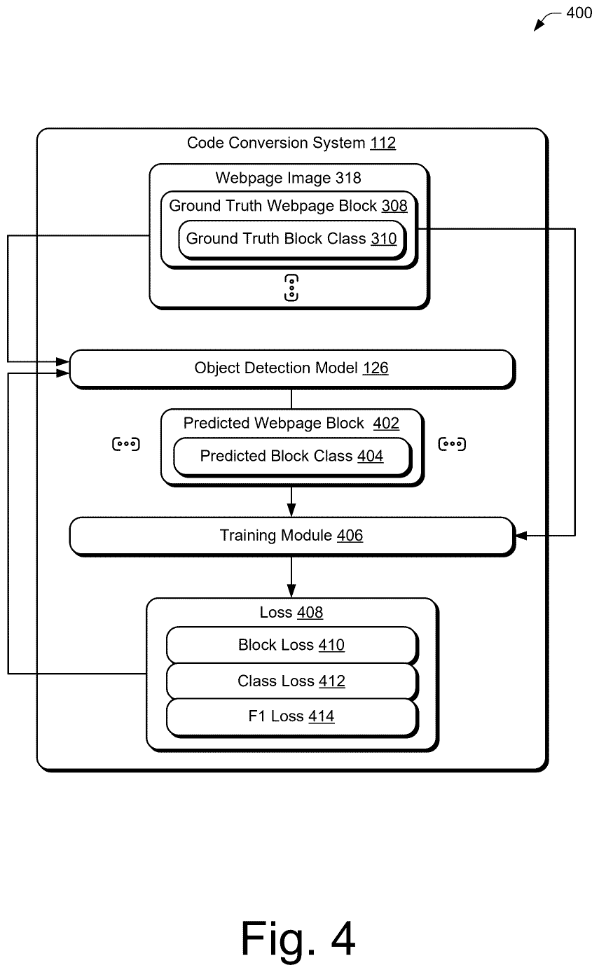

As part of this, the object detection model 126 receives the webpage image 116. As further discussed below with reference to FIG. 4, the object detection model 126 is a machine learning model having been trained to detect webpage blocks 124 and block classes 202 of the webpage publication system 122 in images of webpages 114. For example, the object detection model 126 processes the webpage image 116 to detect a plurality of webpage blocks 124 in the webpage image 116, and assign a block class 202 to each webpage block 124. The output of the object detection model 126 includes the webpage image 116 having bounding boxes surrounding the detected webpage blocks 124. In addition, each webpage block 124 is assigned a corresponding block class 202, such as “hero block,” “footer block,” or “card block.” In other words, the object detection model 126 detects a plurality of user interface components of a webpage 114. In addition, the object detection model 126 selects, from a plurality of block classes 202 specific to the webpage publication system, which block class 202 that each user interface component most closely resembles. Additionally or alternatively, the object detection model 126 outputs coordinates of each detected webpage block 124.

As shown, the webpage blocks 124 having the assigned block classes 202 are provided to a content matching module 206 along with the source code 118 of the webpage 114. Generally, the content matching module 206 is configured to match webpage content 208 of the webpage 114 to corresponding webpage blocks 124. As described herein, webpage content 208 refers to content of the webpage 114 that is output as part of the user interface of the webpage 114, such as text content, image content, video content, or audio content.

As previously mentioned, the source code 118 includes or corresponds to HTML code in various implementations. In these implementations, the content matching module 206 extracts a document object model (DOM) from the HTML code. To do so, the content matching module 206 employs an HTML parser (e.g., DOMparser, BeautifulSOUP, jsoup), which converts the HTML code into a DOM structure. Broadly, the DOM structure includes a plurality of HTML elements (e.g., <div>, <span>, <img>, etc.) of the webpage 114, each represented as a node in a hierarchical tree format. In particular, the DOM structure includes <div> (e.g., “division”) elements, which are used to create distinct sections (e.g., headers, footers, sidebars) of a logical layout of the webpage 114. Thus, the DOM structure includes a parent node representing the webpage 114 as a whole and one or more child nodes representing sections of the webpage identified by <div> elements or nodes. It should be noted that the <div> elements themselves also include child HTML nodes representing content within webpage sections defined by the <div> elements. In other words, the content matching module 206 identifies a plurality of webpage components (e.g., <div> elements) from the source code 118 (e.g., HTML code) of the webpage 114.

In accordance with the described techniques, the content matching module 206 determines the coordinates of the <div> elements of the DOM structure and the HTML code. To do so, the content matching module 206 inspects cascading style sheets (CSS) of the source code 118 of the webpage 114. CSS is a style sheets language specifying the presentation and styling of a document written in a markup language, such as HTML. In particular, the content matching module 206 identifies the coordinates of a <div> element based on the CSS layout properties defining the top, left, width, and height of the <div> element. Additionally or alternatively, the content matching module 206 uses a JavaScript operation (e.g., element.getBoundingClientRect( ), which returns position and dimension properties of a specified HTML (e.g., <div>) element.

Further, the content matching module 206 is configured to match the <div> elements to corresponding webpage blocks 124 based on degrees of overlap between the <div> elements and the detected webpage blocks 124. Given a particular webpage block 124, for instance, the content matching module 206 computes a degree of overlap (e.g., an intersection over union (IoU)) between the coordinates of the particular webpage block 124 and the coordinates of each identified <div> element. Further, the content matching module 206 identifies a particular <div> element exhibiting a highest degree of overlap (e.g., a highest IoU value) with the particular webpage block 124, and matches the particular <div> element to the particular webpage block 124.

In addition, the content matching module 206 extracts webpage content 208 from the particular <div> element, such as text content (e.g., text blobs), images, videos, and/or audio files. Additionally or alternatively, the web content 208 includes alt text associated with image and/or video content, e.g., captions of the image content and/or video content. Finally, the content matching module 206 assigns the webpage content extracted from the particular <div> element to the particular webpage block 124, as shown. In other words, the webpage content 208 assigned to the webpage block 124 includes content (e.g., text content, image content, video content, and audio content) output as part of the user interface of the webpage block 124. This process is repeated match each respective webpage block 124 to a corresponding <div> element, and assign the webpage content 208 of the matching <div> element to the respective webpage block 124.

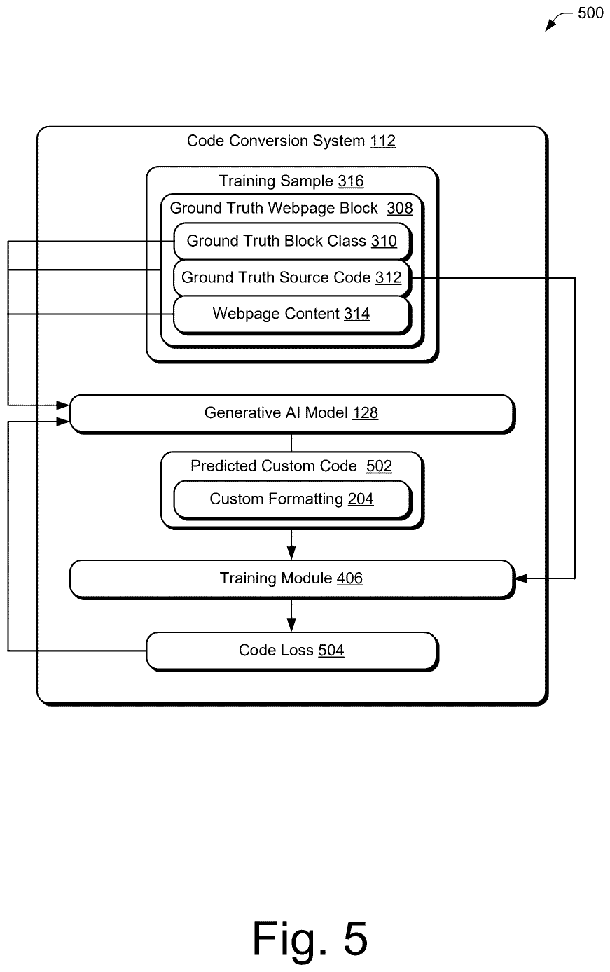

As shown, the webpage blocks 124 each including the assigned block class 202, and the assigned webpage content 208 are provided as input to the generative AI model 128. As further discussed below with reference to FIG. 5, the generative AI model 128 is a machine learning model having been trained to generate the custom code 120 (including the custom formatting 204) from an input comprising a webpage block 124 having an assigned block class 202 and assigned webpage content 208. In particular, the generative AI model 128 is a multimodal machine learning model capable of processing inputs in multiple content modalities, such as text, image video, and/or audio. Broadly, the generative AI model 128 is configured to individually process each respective webpage block 124 to generate the custom code 120 for the respective webpage block 124 formatted in accordance with the webpage publication system 122.

To generate the custom code 120 of an individual webpage block 124, the generative AI model 128 receives, as input, a segmented image of the webpage block 124, an indication of the block class 202 assigned to the webpage block 124, and the webpage content 208 of the webpage block 124. In one or more implementations, different content modalities of the webpage content 208 are provided to the generative AI model 128 via different input channels. For instance, the generative AI model 128 receives text-based webpage content 208 via a first input channel, image-based webpage content 208 via a second input channel, video-based webpage content 208 via a third input channel, audio-based webpage content 208 via a fourth input channel, and alt text via a fifth input channel.

Notably, the various inputs (e.g., the segmented image of the webpage block 124, the block class 202, and the webpage content 208 input channels) provided to the generative AI model 128 include inputs of different content modalities. In accordance with the multimodal functionality of the generative AI model 128, the generative AI model 128 generates embeddings of the various inputs and aligns the embeddings in a common embedding space. The embeddings, for instance, are vectors representing the input content numerically. This enables the generative AI model 128 to represent diverse types of content in a unified manner, such that semantically similar embeddings (regardless of the modality) are close (e.g., in terms of Euclidean distance) within the embedding space.

Here, the generative AI model 128 processes the embeddings to generate the custom code 120 for the webpage block 124 having the system-specific custom formatting 204. In one or more implementations, the generative AI model 128 generates the custom code 120 for a webpage block 124 in an autoregressive fashion, in which one or more previously generated tokens of the custom code 120 are provided as context to the generative AI model 128 for generating a next successive token of the custom code 120 in a sequence. This process is repeated for each detected webpage block 124 in order to generate the custom code 120 (e.g., HTML code) for the entire webpage 114.

In one or more implementations, the machine learning model is a multimodal large language model (MLLM) having been fine-tuned on a training dataset for the purpose of generating the system-specific custom code 120, as further discussed below with reference to FIG. 5. Individually processing data at the webpage block level (rather than the webpage level) improves quality of the automatically generated custom code 120 in a variety of ways. Notably, MLLMs have a fixed context length, which limits the amount of data that the MLLM can process (e.g., as input or as output) at once. Since HTML code for a full webpage often exceeds this fixed context length, currently available MLLMs are typically unable to generate HTML code for an entire webpage. Moreover, when an image of a webpage is processed in its entirety by an MLLM, the model struggles to parse and interpret small, precise details. This is because processing fine-grained details across a large, complex visual (e.g., a full webpage) is beyond what MLLMs can effectively analyze, leading to inaccuracies. Thus, processing individual webpage blocks 124 (rather than an entire webpage 114) enables outputs that are within the MLLM's fixed context length, and improves the MLLM's interpretation of fine granularity visual details.

Thus, given a webpage image 116, the code conversion system 112 detects user interface components of the webpage 114, and determines which system-specific block class 202 that each detected user interface component most closely resembles. Further, the generative AI model 128 converts the detected webpage blocks 124 having assigned block classes 202 and webpage content 208 to custom code 120 formatted in accordance with the webpage publication system 122. By assigning system-specific block classes 202 to webpage components of an existing webpage, the custom code 120 preserves visual characteristics and functionality of the existing webpage while enabling advantages offered by the webpage publication system 122, e.g., increased authoring efficiency, reduced content delivery latency, and enhanced data load speeds.

Although examples are depicted and described herein in which the code conversion system 112 receives, as input, the webpage 114 having the webpage image 116 and the source code 118, these examples are not to be construed as limiting. Instead, the code conversion system 112 receives, as input, a webpage image 116 of a mock-up design of a webpage that has not yet been constructed (e.g., having no underlying source code) in one or more implementations. Here, rather than extracting the webpage content 208 from the source code 118, the content matching module 206 extracts the webpage content 208 from the webpage image 116. For instance, the content matching module 206 receives the webpage image 116 including the bounding boxes defining the webpage blocks 124. Further, the content matching module 206 assigns, to a webpage block 124, visual webpage content (e.g., text content, image content, and video content) that is contained within the bounding box defining the webpage block 124.

Moreover, while examples of the described techniques are described herein as converting HTML code of the webpage 114 to custom HTML code 120 of the webpage publication system 122, HTML code is not to be construed as limiting. Rather, the described techniques are extendable to convert source code 118 of the webpage 114 to custom code 120 of other style sheet languages, markup languages, programming languages, and/or data-interchange formats specific to the webpage publication system 122. Examples of these languages include, but are not limited to, CSS, Javascript, extensible markup language (XML), JavaScript Object Notation (JSON).

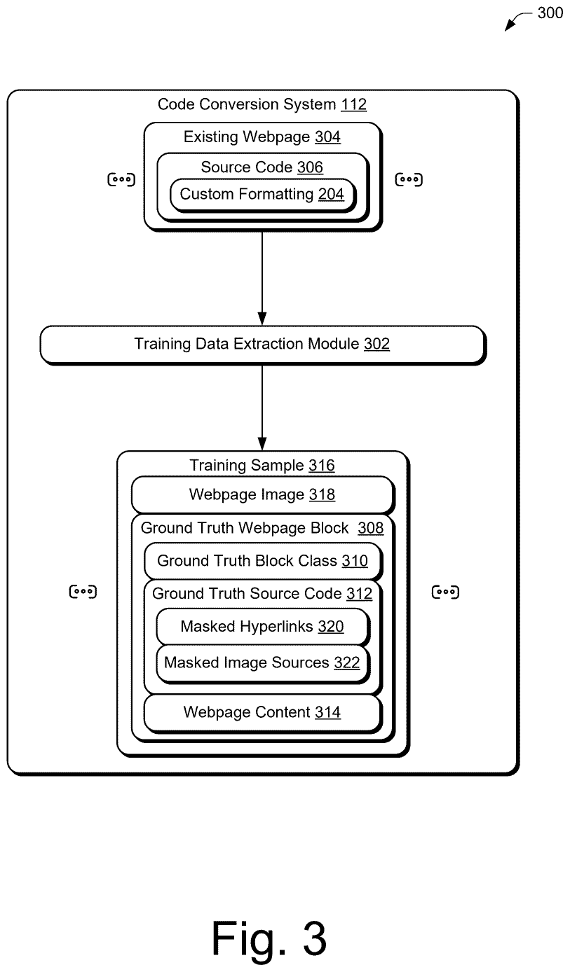

FIG. 3 depicts a system 300 in an example implementation showing operation of the code conversion system to extract training data from existing webpages formatted in accordance with the webpage publication system. A training data extraction module 302 of the code conversion system 112 receives a plurality of existing webpages 304 formatted in accordance with the webpage publication system 122. For example, the existing webpages 304 include the webpage blocks 124 having assigned block classes 202 specific to the webpage publication system 122. Moreover, the existing webpages 304 include source code 306 (e.g., HTML) including the custom formatting 204. In general, the training data extraction module 302 is configured to extract training data for training the object detection model 126 and the generative AI model 128 from the existing webpages 304.

To do so, the training data extraction module 302 extracts, from the source code 306 (e.g., HTML) of an existing webpage 304, a ground truth webpage block 308, a ground truth block class 310 assigned to the ground truth webpage block 308, ground truth source code 312 of the ground truth webpage block 308, and webpage content 314 output as part of the user interface of the ground truth webpage block 308. Given an existing webpage 304, for instance, the training data extraction module 302 extracts a DOM from the source code 118 (e.g., HTML) using an HTML parser. In accordance with the custom formatting 204 of the webpage publication system 122, webpage blocks 124 are <div> elements of the HTML code and/or DOM associated with a class name corresponding to one of the plurality of block classes 202 of the webpage publication system 122. Thus, the training data extraction module 302 identifies a <div> element having a class name corresponding to a block class 202 of the webpage publication system 122, e.g., “hero block.” Moreover, the training data extraction module 302 extracts coordinates of the identified <div> element, e.g., by inspecting the CSS of the source code 306 or using a JavaScript operation, such as element.getBoundingClientRect( ) The extracted coordinates of the <div> element identify the ground truth webpage block 308 of a training sample 316.

In addition, the training data extraction module 302 extracts, as the ground truth block class 310 of the ground truth webpage block 308, the class name of the corresponding <div> element. Furthermore, the training data extraction module 302 extracts, as the ground truth source code 312 of the ground truth webpage block 308, the HTML code associated with the corresponding <div> element. Moreover, the training data extraction module 302 extracts, as the webpage content 314 of the ground truth webpage block 308, the text content (including alt text), image content, video content, and/or audio content of the corresponding <div> element. In addition, the training sample 316 includes a webpage image 318 of the existing webpage 304 from which the ground truth training webpage block 308 was extracted.

As shown, the training data extraction module 302 is configured to mask hyperlinks (e.g., links to external webpages) and image sources in the ground truth source code 312. In other words, the ground truth source code 312 includes one or more masked hyperlinks 320 and one or more masked image sources 322. Notably, image sources include uniform resource locator (URL) paths to images, which are embedded in a webpage. To mask this data, the training data extraction module 302 identifies hyperlinks and image source in the ground truth source code 312, and replaces the hyperlinks and image sources with placeholder tokens, e.g., <hyperlink> and <image> tokens.

This process is repeated to generate a plurality of training samples 316 for a plurality of ground truth webpage blocks 308 within a plurality of existing webpages 304. As shown, each training sample 316 includes a ground truth webpage block 308 and a webpage image 318 from which the ground truth webpage block 308 was extracted. In variations, the ground truth webpage block 308 is a segmented image of the ground truth webpage block 308 and/or a bounding box within the webpage image 318 surrounding the ground truth webpage block 308. Moreover, the ground truth webpage block 308 includes a ground truth block class 310, ground truth source code 312 (e.g., HTML code) of the ground truth webpage block 308, and webpage content 314 output as part of the user interface of ground truth webpage block 308. Further, the ground truth source code 312 includes the masked hyperlink(s) 320 and/or the masked image source(s) 322.

FIG. 4 depicts a system 400 in an example implementation showing operation of the code conversion system to train an object detection model to detect webpage blocks and corresponding block classes of a webpage publication system. As shown, the webpage image 318 of an existing webpage 304 is provided as input to the object detection model 126. Based on the webpage image 318, the object detection model 126 detects a plurality of predicted webpage blocks 402 in the webpage image 318, and assigns a predicted block class 404 to each predicted webpage block 402 in accordance with the described techniques.

The predicted webpage blocks 402 (having the predicted block classes 404) are provided as input to a training module 406. In addition, the training module 406 receives the ground truth webpage blocks 308 of the webpage image 318, and each of the ground truth webpage blocks 308 include a ground truth block class 310, as shown. In other words, the training module 406 receives the ground truth webpage blocks 308 and associated ground truth block classes 310 of training samples 316 extracted from the existing webpage 304 associated with the webpage image 318. Generally, the training module 406 is configured to determine a loss 408 (e.g., using a loss function) based on differences between predicted outputs of the object detection model 126 and the ground truth data, and update the object detection model 126 to reduce the loss.

To do so, the training module 406 pairs the predicted webpage blocks 402 with corresponding ground truth webpage blocks 308. In the context of training the object detection model 126, for instance, the ground truth webpage blocks 308 and the predicted webpage blocks 402 are represented as bounding boxes within the webpage image 318. Given this, the training module 406 computes degrees of overlap (e.g., IoUs) between a predicted webpage block 402 and the ground truth webpage blocks 308. Furthermore, the training module 406 pairs the predicted webpage block 402 with a particular ground truth webpage block 308 exhibiting a highest degree of overlap with the predicted webpage block 402. This process is repeated to generate a plurality of pairs, each including a predicted webpage block 402 and a ground truth webpage block 308.

Given a pair of corresponding webpage blocks 308, 402, the training module 406 computes a block loss 410 based on a comparison of the predicted webpage block 402 of the pair and the ground truth webpage block 308 of the pair. For instance, a lower degree of overlap (e.g., a lower value of the IoU) between the predicted webpage block 402 and the ground truth webpage block 308 produces a higher block loss 410, and vice versa. In one or more implementations, this process is repeated for each pair of the plurality of pairs, such that the overall block loss 410 is an average value of the block losses 410 across the plurality of pairs.

In addition, the training module 406 computes a class loss 412 based on a comparison of the predicted block class 404 of the pair and the ground truth block class 310 of the pair. In one example, the class loss 412 is based on whether the predicted block class 404 is the ground truth block class 310. Additionally or alternatively, the object detection model 126 outputs, for the predicted webpage block 402, a prediction vector of confidence values (e.g., between zero and one) each corresponding to a block class 202 of the webpage publication system 122. The confidence value corresponding to a block class 202 is a degree of confidence that the predicted webpage block 402 corresponds to the block class 202, and not a different block class. Moreover, the ground truth block class 310 is a ground truth vector of values each corresponding to a block class 202, with the ground truth block class 310 populated with a value of one and the remining block classes populated with a value of zero. Given this, the class loss 412 is a distance between the ground truth vector and the prediction vector. In one or more implementations, this process is repeated for each pair of the plurality of pairs, such that the overall class loss 412 is an average value of the class losses 412 across the plurality of pairs.

Moreover, the training module 406 computes an F1 loss 414 for the webpage image 318. Generally, an F1 score measures precision and recall of the object detection model 126. For example, F1 score is calculated based on the following relationships:

$$F 1 = 2 \times \frac{Precision \times Recall}{Precision + Recall}$$

$$Precision = \frac{True Positives}{True Positives + False Positives}$$

$$Recall = \frac{True Positives}{True Positives + False Negatives}$$

Here, true positives are correctly identified predicted webpage blocks 402 in the webpage image 318 (e.g., predicted webpage blocks 402 having an overlapping ground truth webpage block 308), false positives are incorrectly identified predicted webpage blocks 402 in the webpage image 318 (e.g., predicted webpage blocks 402 that do not have an overlapping ground truth webpage block 308), and false negatives are ground truth webpage blocks 308 that are missed (not detected) by the model 126. Moreover, the F1 loss 414 is based on a degree to which the F1 score for the webpage image 318 has increased since a previous training iteration or epoch, e.g., with a larger increase in the F1 score resulting in a smaller value of the F1 loss.

In accordance with the described techniques, the training module 406 calculates the loss 408 by combining the block loss 410, the class loss 412, and the F1 loss 414. In various implementations, the different loss terms (e.g., the block loss 410, the class loss 412, and the F1 loss 414) are weighted differently. Furthermore, the training module 406 adjusts parameters (e.g., internal weights) of the object detection model 126 to minimize the loss 408. This process is repeated on different webpage images 318 (e.g., training samples) until a threshold number of the webpage images 318 have been processed, a threshold number of epochs have been processed, or the loss 408 converges to a minimum value.

In one or more implementations, the object detection model 126 is a pre-trained object detection model (e.g., a YOLOv8 model) that is fine-tuned and/or refined using the above-described training data. Additionally or alternatively, the object detection model 126 is trained from scratch (e.g., starting with randomly initialized parameters) using the above-described training data.

FIG. 5 depicts a system 500 in an example implementation showing operation of the code conversion system to train a generative artificial intelligence model to generate custom code of a webpage publication system. Here, the ground truth webpage block 308, the ground truth block class 310, and the webpage content 314 of a training sample 316 are provided as input data to the generative AI model 128. Based on the input data, the generative AI model 128 generates predicted custom code 502 in accordance with the described techniques. For example, the generative AI model 128 aims to generate the predicted custom code 502 having the custom formatting 204, e.g., following the code formatting guidelines of the webpage publication system 122.

As shown, the predicted custom code 502 and the ground truth source code 312 of the training sample 316 are provided as input to the training module 406, which is configured to determine a code loss 504 (e.g., using a loss function) based on a comparison of the predicted custom code 502 and the ground truth source code 312. In one example, the code loss 504 is based on the edit distance (e.g., Levenshtein distance) between the predicted custom code 502 and the ground truth source code 312. In another example, the code loss 504 is based on the Jaccard similarity (e.g., IoU) between a set of tokens of the predicted custom code 502 and a set of tokens of the ground truth source code 312. Additionally or alternatively, the code loss 504 is based on a comparison of DOM structures extracted from the two sets of code 312, 502 using a Tree Edit Distance algorithm and/or XPath-based comparisons.

Here, the training module 406 is configured to adjust parameters (e.g., internal weights) of the generative AI model 128 to minimize the code loss 504. This process is repeated on different training samples 316 until a threshold number of training samples 316 have been processed, a threshold number of epochs have been processed, or the code loss 504 converges to a minimum value. In one or more implementations, the generative AI model 128 is a pre-trained MLLM (e.g., an internVL2-8B model) that is fine-tuned and/or refined using the above-described training data. Additionally or alternatively, the generative AI model 128 is a multimodal machine learning model that is trained from scratch (e.g., starting with randomly initialized parameters) using the above-described training data.

As previously mentioned, the ground truth source code 312 includes the masked hyperlinks 320 and the masked image sources 322. By masking this data, the code conversion system 112 prevents the generative AI model 128 from learning to generate webpage-specific HTML code. Indeed, the code conversion system 112 prevents the generative AI model 128 from generating hyperlinks and image sources that are not part of the custom formatting 204 of the webpage publication system 122. Instead, the generative AI model 128 generates generic placeholder tokens, which are populatable by developers to which the custom code 120 is surfaced.

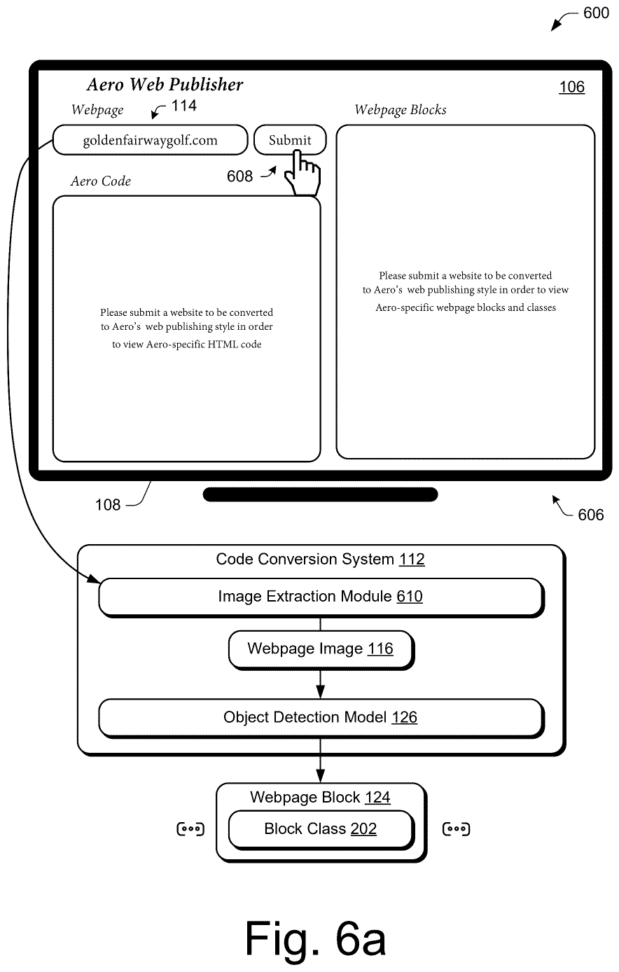

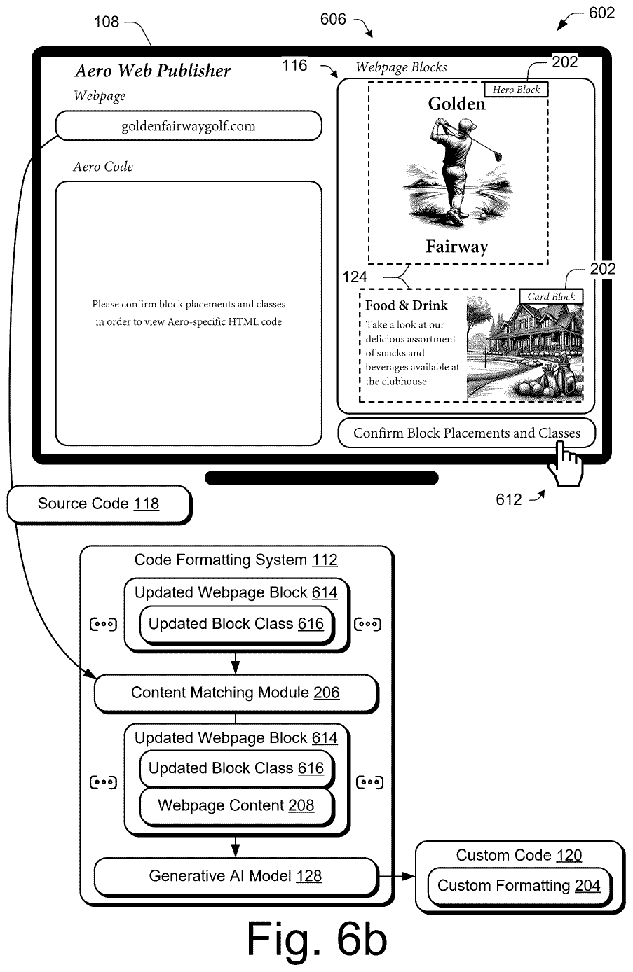

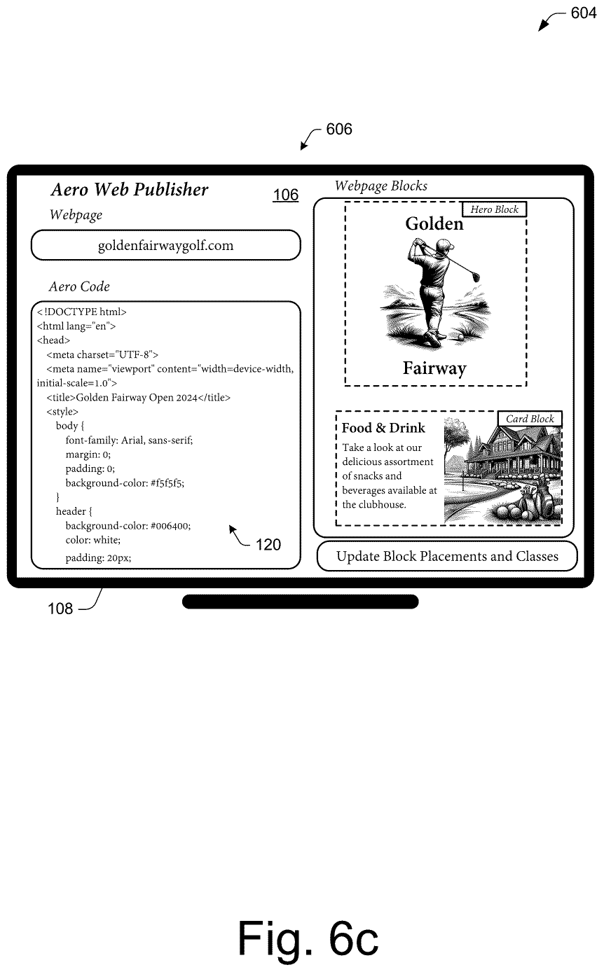

FIGS. 6a-6c depict examples 600, 602, 604 of a user interface of the described techniques for custom webpage code conversion using generative artificial intelligence. The examples 600, 602, 604 include a client device 606 having a display device 108 displaying a user interface 106. In particular, FIG. 6a depicts a first example 600 of the user interface 106, FIG. 6b depicts a second example 602 of the user interface 106, and FIG. 6c depicts a third example 604 of the user interface 106. In addition, the examples 600, 602, 604 include the code conversion system 112, which is implemented locally at the client device 606 or by a remote service provider system (e.g., as part of a web service or “in the cloud”) in variations.

In the first example 600, a user provides user input specifying a link to a webpage 114 via the user interface 106. The link is then communicated to the code conversion system responsive to a user input 608 submitting the link to the code conversion system 112. In particular, the link is communicated to an image extraction module 610 of the code conversion system 112, which accesses the webpage 114 using the link and extracts the webpage image 116 from the webpage 114. In accordance with the described techniques, the object detection model 126 detects webpage blocks 124 in the webpage image 116, and assigns a block class 202 to each detected webpage block 124. The webpage blocks 124 having the assigned block classes 202 are then communicated to the display device 108 for display in the user interface 106.

As shown in the second example 602, for instance, the user interface 106 includes the webpage image 116 having webpage blocks 124, and block classes 202 assigned to the webpage blocks 124. By way of example, the webpage blocks 124 are illustrated as dashed lines (e.g., bounding boxes) surrounding the content of the detected webpage blocks 124. Further, a first webpage block 124 is assigned a block class 202 of “Hero Block,” and a second webpage block 124 is assigned a block class 202 of “Card Block,” as shown.

In one or more implementations, the user interface 106 provides functionality for enabling user input to update the placements of the webpage blocks 124 and/or update the block classes 202 assigned thereto. In this way, a developer can correct inaccurately detected webpage blocks 124 and/or inaccurately assigned block classes 202 by the object detection model 126. By doing so, a developer is able to ensure that the webpage blocks 124 and block classes 202 are accurate before submitting to the generative AI model 128 for custom code 120 generation. Here, the developer provides user input adjusting placements of the webpage blocks 124, adding new webpage blocks 124, removing webpage blocks 124, and/or changing the block classes 202 assigned to one or more webpage blocks 124.

In response to a user input 612, the updated webpage blocks 614 and the updated block classes 616 are communicated to the code conversion system 112. In particular, the updated webpage blocks 614 and the updated block classes 616 are provided to the content matching module 206. In addition, the content matching module 206 retrieves the source code 118 (e.g., HTML code) from the webpage 114 identified by the link. In accordance with the described techniques, the content matching module 206 extracts webpage content 208 from the source code 118, and matches the webpage content 208 to corresponding updated webpage blocks 614, as shown.

In one or more implementations, the updated webpage blocks 614 and the updated block classes 616 are used as training data to further train the object detection model 126 during model deployment. By way of example, the object detection model 126 is trained in accordance with the techniques discussed above with reference to FIG. 4. Here, the updated webpage blocks 614 and the updated block classes 616 are treated as the ground truth webpage blocks 308 and the ground truth block classes 310. Further, the webpage blocks 124 and the block classes 202 originally output by the object detection model 126 are treated as the predicted webpage blocks 402 and the predicted block classes 404.

Here, the generative AI model 128 generates the custom code 120 having the custom formatting 204 based on the updated webpage blocks 614 having the updated block classes 616 and the webpage content 208 in accordance with the described techniques. Furthermore, the custom code 120 is communicated to the display device 108 for display in the user interface 106. As shown in the third example 604, for instance, the user interface 106 includes the custom code 120 formatted in accordance with the code formatting guidelines of the webpage publication system 122, e.g., Aero Web Publisher. In one or more implementations, the user interface 106 provides functionality enabling user input to update the custom code 120. It should be noted that the custom code 120 of FIG. 6c is merely illustrative, and does not reflect functional code following the code formatting guidelines of the webpage publication system 122.

In the examples 600, 602, 604, data is described communicated between the display device 108 of the client device 606 and the code conversion system 112. In various implementations, the client device 606 is the computing device 102 including the code conversion system 112, and this data is communicated internally within the computing device. In one or more alternative implementations, the computing device 102 including the code conversion system 112 is a remote server of a remote service provider system, and functionality of the code conversion system 112 is provided to the client device 606 as a web service. In these implementations, data is exchanged between the client device 606 and the code conversion system via data communications over the network 110.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-6c.

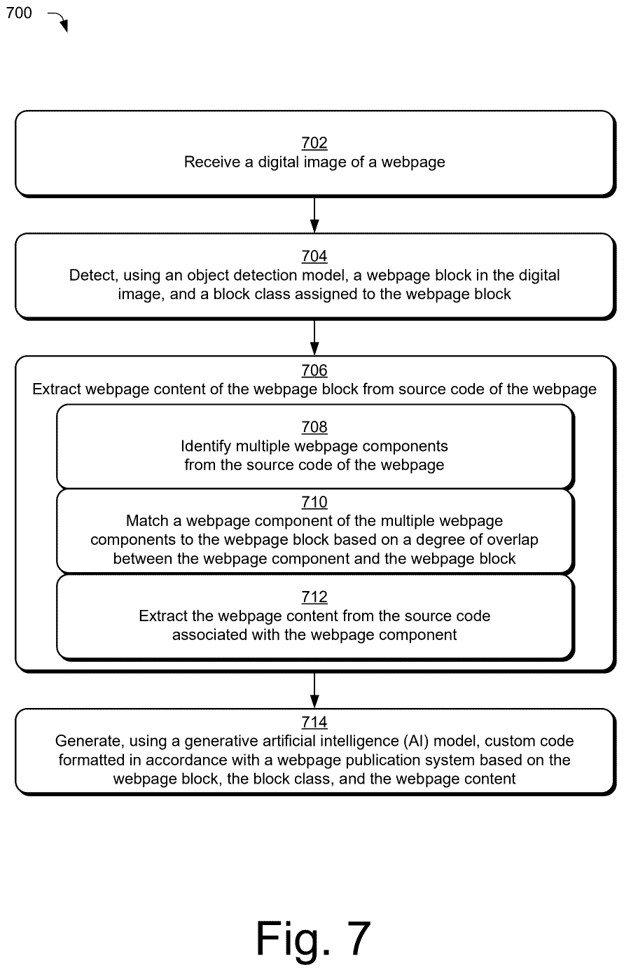

FIG. 7 is a flow diagram depicting a procedure 700 in an example implementation of using a generative artificial intelligence model to convert a webpage to custom webpage code formatted in accordance with a webpage publication system. In the procedure 700, a digital image of a webpage is received (block 702). For example, the code conversion system 112 receives the webpage image 116.

A webpage block in the digital image and a block class assigned to the webpage block are detected using an object detection model (block 704). Based on the webpage image 116 as input, the object detection model 126 detects webpage blocks 124 and block classes 202 assigned to the webpage blocks 124. The block classes 202 are types of webpage blocks 124 specific to the webpage publication system 122.

Webpage content of the webpage block is extracted from source code of the webpage (block 706), and as part of this, multiple webpage components are identified from the source code of the webpage (block 708). For example, the content matching module 206 extracts a DOM from the source code 118 (e.g., HTML code), and identifies <div> elements (e.g., webpage components) therein. In addition, the content matching module 206 identifies coordinates of the <div> elements.

A webpage component of the multiple webpage components is matched to a webpage block based on a degree of overlap between the webpage component and the webpage block (block 710). For example, the content matching module 206 computes a degree of overlap between the webpage block 124 and each identified <div> element. In addition, the content matching module 206 matches the webpage block 124 to a <div> element exhibiting a highest degree of overlap with the webpage block 124.

The webpage content is extracted from the source code associated with the webpage component (block 712). By way of example, the content matching module 206 extracts webpage content 208 (e.g., output as part of the user interface) of the <div> element. The extracted webpage content 208 (e.g., text content, image content, video content, audio content) is assigned to the webpage block 124.

Custom code formatted in accordance with a webpage publication system is generated using a generative AI model based on the webpage block, the block class, and the webpage content (block 714). For example, the generative AI model 128 receives as input, the webpage block 124, the block class 202 assigned to the webpage block 124, and the webpage content 208 of the webpage block 124. Based on this input data, the generative AI model 128 generates custom code 120 that follows code formatting guidelines of the webpage publication system 122.

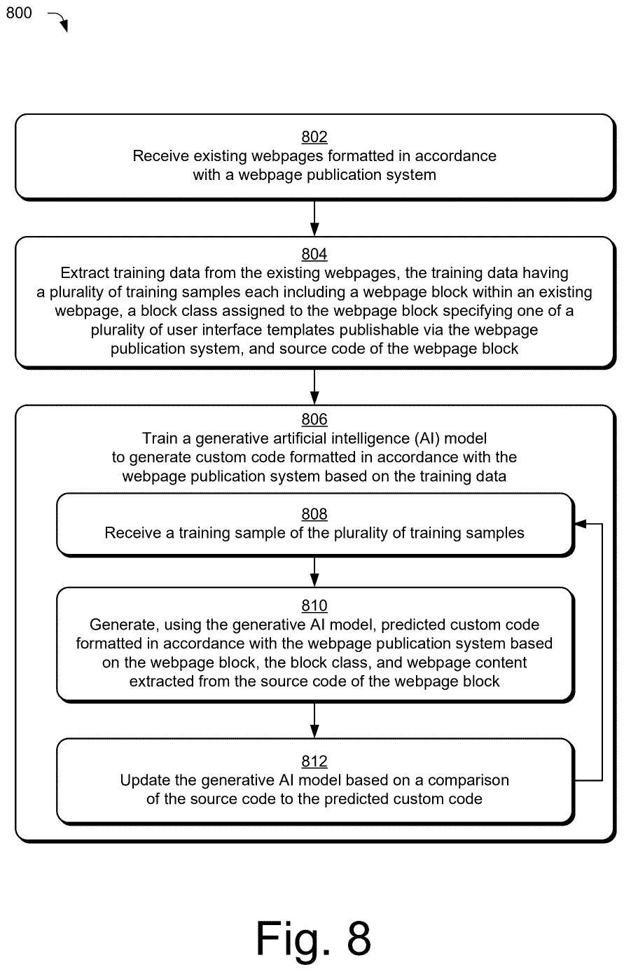

FIG. 8 is a flow diagram depicting a procedure 800 in an example implementation of training a generative artificial intelligence model to convert a webpage to custom webpage code formatted in accordance with a webpage publication system. In the procedure 800, existing webpages are received, and the existing webpages are formatted in accordance with a webpage publication system (block 802). For example, the training data extraction module 302 receives a plurality of existing webpages 304 that are built on and published by the webpage publication system 122. The existing webpages 304 include source code 306 following the custom formatting 204, e.g., following code formatting guidelines specific to the webpage publication system 122.

Training data is extracted from the existing webpages, and the training data has a plurality of training samples each including a webpage block within an existing webpage, a block class assigned to the webpage block specifying one of a plurality of user interface templates publishable via the webpage publication system, and source code of the webpage block (block 804). For example, the training data extraction module 302 extracts a plurality of training samples 316 from the existing webpages 304. Each training sample 316 includes a ground truth webpage block 308, a ground truth block class 310 assigned to the ground truth webpage block 308, and ground truth source code 312 of the ground truth webpage block 308. The ground truth block class 310 of a training sample 316 is one of a plurality of block classes 202 (e.g., user interface templates) that are creatable, editable, and publishable via the webpage publication system 122 as part of a webpage.

A generative AI model is trained to generate custom code formatted in accordance with the webpage publication system based on the training data (block 806), and as part of this, a training sample of the plurality of training samples is received (block 808). By way of example, the code conversion system 112 receives a training sample 316.

Predicted custom code is generated using the generative AI model based on the webpage block, the block class, and webpage content extracted from the source code of the webpage block, and the predicted custom code is formatted in accordance with the webpage publication system (block 810). By way of example, the generative AI model 128 receives the ground truth webpage block 308, a ground truth block class 310, and webpage content 314 (e.g., extracted from the ground truth source code 312) of the training sample 316 as input. Based on this input data, the generative AI model 128 generates predicted custom code 502 having the custom formatting 204.

The generative AI model is updated based on a comparison of the source code to the predicted custom code (block 812). For example, the training module 406 determines a code loss 504 based on a comparison of the ground truth source code 312 to the predicted custom code 502. Furthermore, the training module 406 updates parameters (e.g., internal weights) of the generative AI model 128 to reduce the code loss 504. As shown, the training process is repeated on additional training samples 316, e.g., until the code loss 504 converges, or a threshold number of training iterations or epochs have been processed.

### Example System and Device

FIG. 9 illustrates an example system generally at 900 that includes an example computing device 902 that is representative of one or more computing systems and/or devices that implement the various techniques described herein. This is illustrated through inclusion of the code conversion system 112. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” “component,” and “system” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a digital image of a webpage;
detecting, by the processing device and using an object detection model, a webpage block in the digital image, and a block class assigned to the webpage block;
extracting, by the processing device, webpage content of the webpage block from source code of the webpage; and
generating, by the processing device and using a generative artificial intelligence (AI) model, custom code formatted in accordance with a webpage publication system based on the webpage block, the block class, and the webpage content.

2. The method of claim 1, wherein the detecting the block class includes selecting the block class from a plurality of block classes detectable by the object detection model, the plurality of block classes corresponding to different webpage components of the webpage publication system.

3. The method of claim 1, wherein the webpage content includes one or more of image content, text content, video content, or audio content output as part of the webpage block.

4. The method of claim 1, wherein the extracting the webpage content includes:
identifying multiple webpage components from the source code of the webpage;
matching a webpage component of the multiple webpage components to the webpage block based on a degree of overlap between the webpage component and the webpage block; and
extracting the webpage content from the source code associated with the webpage component.

5. The method of claim 1, wherein the source code and the custom code are written in a markup language.

6. The method of claim 1, further comprising:
receiving, by the processing device, existing webpages formatted in accordance with the webpage publication system; and
extracting, by the processing device, training data for training the object detection model and the generative AI model from the existing webpages.

7. The method of claim 6, wherein the training data includes a plurality of training samples each including a ground truth webpage block of an existing webpage, a ground truth block class assigned to the ground truth webpage block, and ground truth source code of the ground truth webpage block.

8. The method of claim 7, wherein the ground truth webpage block and the ground truth block class are extracted from the ground truth source code.

9. The method of claim 7, further comprising masking hyperlinks and image sources in the ground truth source code.

10. The method of claim 7, further comprising training, by the processing device, the object detection model, in part, by:
receiving a training sample of the plurality of training samples;
detecting, using the object detection model, a predicted webpage block in a training image of the existing webpage, and a predicted block class assigned to the predicted webpage block; and
updating the object detection model based on a first comparison of the ground truth webpage block to the predicted webpage block, and a second comparison of the ground truth block class to the predicted block class.

11. The method of claim 7, further comprising training, by the processing device, the generative AI model, in part, by:
receiving a training sample of the plurality of training samples;
generating, using the generative AI model, predicted custom code formatted in accordance with the webpage publication system based on the ground truth webpage block, the ground truth block class, and webpage content of the ground truth webpage block; and
updating the generative AI model based on a comparison of the ground truth source code to the predicted custom code.

12. The method of claim 1, further comprising:
presenting, in a user interface, a bounding box representing the webpage block and an indication of the block class; and
receiving, via the user interface, user input updating at least one of the webpage block or the block class.

13. A system comprising:
a processing device; and
a computer-readable medium storing instructions that, responsive to execution by the processing device, cause the processing device to perform operations including:
receiving, via a user interface, user input specifying a link to a webpage;
presenting, in the user interface, a webpage block and a block class assigned to the webpage block, the webpage block and the block class detected using an object detection model based on a digital image of the webpage; and
presenting, in the user interface, custom code formatted in accordance with a webpage publication system, the custom code generated using a generative artificial intelligence (AI) model based on the webpage block, the block class, and webpage content of the webpage block extracted from source code of the webpage.

14. The system of claim 13, wherein the block class is selected by the object detection model from a plurality of block classes corresponding to different webpage components of the webpage publication system.

15. The system of claim 13, wherein the webpage content includes one or more of image content, text content, video content, or audio content output as part of the webpage block.

16. The system of claim 13, the operations further comprising receiving, via the user interface, user input updating at least one of the webpage block, the block class, or the custom code.

17. A non-transitory computer-readable medium storing executable instructions, which when executed by a processing device, cause the processing device to perform operations comprising:
receiving existing webpages formatted in accordance with a webpage publication system;
extracting training data from the existing webpages, the training data having a plurality of training samples each including a webpage block within an existing webpage, a block class assigned to the webpage block specifying one of a plurality of user interface templates publishable via the webpage publication system, and source code of the webpage block; and
training a generative artificial intelligence (AI) model to generate custom code formatted in accordance with the webpage publication system based on the training data.

18. The non-transitory computer-readable medium of claim 17, wherein the webpage block and the block class are extracted from the source code.

19. The non-transitory computer-readable medium of claim 17, further comprising masking hyperlinks and image sources in the source code.

20. The non-transitory computer-readable medium of claim 17, wherein the training the generative AI model includes:
receiving a training sample of the plurality of training samples;
generating, using the generative AI model, predicted custom code formatted in accordance with the webpage publication system based on the webpage block, the block class, and webpage content extracted from the source code of the webpage block; and
updating the generative AI model based on a comparison of the source code to the predicted custom code.
